(19) United States
(12) Patent Application Publication
(10) Pub. No.: US 2015/0342419 A1
(43) Pub. Date: Dec. 3, 2015

(54) SECUREMENT DEVICE

(71) Applicant: UMBRA LLC, BUFFALO, NY (US)

(72) Inventor: Joel Yatscoff, Toronto (CA)

(73) Assignee: UMBRA LLC, BUFFALO, NY (US)

(21) Appl. No.: 14/288,930

(22) Filed: May 28, 2014

(51) Int. Cl. A47K 3/28; A47B 81/00; F16B 45/04

(52) U.S. Cl. CPC A47K 3/281; F16B 45/04; A47B 81/00

(57) ABSTRACT

An apparatus for securing bathroom accessories including a housing operatively arranged to engage a shower head pipe, the housing including an opening and a locking member rotatably secured to the housing, the locking member operatively arranged to close the opening of the housing. An apparatus for securing bathroom accessories including a first substantially c-shaped member, a second substantially c-shaped member fixedly secured to the first substantially c-shaped member, a resilient member arranged between the first substantially c-shaped member and the second substantially c-shaped member. The resilient member is operatively arranged to surround a shower head pipe and prevent the first substantially c-shaped member and the second substantially c-shaped member from slipping.

### FIELD OF THE INVENTION

The invention broadly relates to securement devices, and more particularly, to lockable devices for securing bathroom storage and organizers to shower head pipes.

### BACKGROUND OF THE INVENTION

Hanging bathroom accessories exist for providing bathroom storage and organization. Some accessories provide a convenient place to hang a bath towel or robe. Other accessories provide a convenient place to neatly organize shampoos, conditioners, body washes, loofahs, and other bathing necessities, such as bars of soap. Some hanging bathroom accessories are securable to flat surfaces, such as walls and doors, using suction cups. Other hanging bathroom accessories are arranged to hang on shower heads, doors, and walls. Such hanging bathroom accessories are typically sealed to be protected against rust and/or deterioration. Additionally, such hanging bathroom accessories are typically slip-resistant so that they do not inadvertently veer from their desired hanging position.

U.S. Pat. No. 3,266,764 (F.S. Briles) discloses a shower pipe hanger which is arranged to be secured to a bent portion of a pipe. As described and shown in FIG. 5 of the patent, the hanger includes separate upper and lower body sections which are interengaged about the pipe. Unfortunately, the upper and/or the lower body sections can become misplaced since they are not integral. The shower pipe hanger disclosed in the '764 patent does not include an integral locking member which is simply rotatable about the pipe.

United States Patent Application Publication No. 2009/0188880 (Yang et al.) discloses a shelving system configured as a shower caddy or organizer. The shower caddy disclosed includes an openable loop mechanism which is securable to a shower head pipe to support the weight of the caddy. The openable loop mechanism is closed by means of hinges or a pivot connection. The caddy also discloses a resilient member on at least a portion of an inner periphery of the loop mechanism shaped to fit snugly around a standard shower head pipe. The resilient member prevents movement between the pipe and the caddy. Unfortunately, the caddy does not include an integral locking member which is simply rotatable about a pipe. Additionally, the caddy does not include a resilient member which can accommodate pipes having a variety of angles and widths.

United States Patent Application Publication No. 2008/0224011 (Chang) discloses a shower caddy attachment device which is securable only to a linear portion of a shower head pipe. The attachment device has a lower clamp that is pivotally connected to the hook or loop surrounding the pipe. Unfortunately, the attachment device does not include an integral locking member which is simply rotatable about a pipe. Additionally, the attachment device cannot be secured to angled pipes.

Thus, there is a long felt need for a securement device that is easily securable to a shower pipe and includes an integral locking member that simply rotates about the pipe. There is also a long-felt need for a securement device that can be effectively secured to most pipes regardless of pipe angle or pipe width.

### BRIEF SUMMARY OF THE INVENTION

The present invention is an apparatus for securing bathroom accessories including a housing operatively arranged to engage a shower head pipe, the housing including an opening and a locking member rotatably secured to the housing, the locking member operatively arranged to close the opening of the housing.

The present invention is also an apparatus for securing bathroom accessories including a first substantially c-shaped member, a second substantially c-shaped member fixedly secured to the first substantially c-shaped member, and a resilient member arranged between the first substantially c-shaped member and the second substantially c-shaped member. The resilient member is operatively arranged to surround a shower head pipe and prevent the first substantially c-shaped member and the second substantially c-shaped member from slipping.

In another embodiment, the present invention is an apparatus for securing bathroom accessories including a housing operatively arranged to engage a shower head pipe, the housing including an outer member, an inner member and a resilient member arranged between the outer member and the inner member and a locking member rotatably secured to the housing. The locking member is concentric with the housing.

It is a primary object of the present invention to provide a securement device that is easily securable to a shower pipe and includes an integral locking member that simply rotates about the pipe.

It is a general object of the present invention to provide a device that secures to most shower head pipes regardless of pipe angle and/or width as it exits from the shower wall.

It is another object of the invention to provide a device which relies on the position of its offset rubber contact surfaces and weight for securing bathroom storage devices and organizers.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1A is a left perspective view of an apparatus of the present invention, showing the device securing a bathroom accessory;

FIG. 1B is a right perspective view of an apparatus shown in FIG. 1A, showing the device securing the bathroom accessory shown in FIG. 1A;

FIG. 2 is a front elevational view of the apparatus shown in FIGS. 1A and 1B;

FIG. 3A is a partial exploded elevational perspective view of the apparatus shown in FIG. 1B;

FIG. 3B is an exploded elevational perspective view of the apparatus shown in FIG. 1B;

FIG. 4 is a left side elevational view of the apparatus shown in FIG. 2;

FIG. 5 is a right side elevational view of the apparatus shown in FIG. 2;

FIG. 6 is a top plan elevational view of the apparatus shown in FIG. 2;

FIG. 7 is a bottom plan elevational view of the apparatus shown in FIG. 2;

FIG. 8 is a rear elevational view of the apparatus shown in FIG. 2;

FIG. 9 is a front elevational view of the apparatus in an unlocked position; and,

FIG. 10 is a front elevational view of the apparatus shown in FIG. 9 with the shower head pipe partially surrounded by the resilient member of the invention.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspect. The present invention is intended to include various modifications and equivalent arrangements within the spirit and scope of the appended claims.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

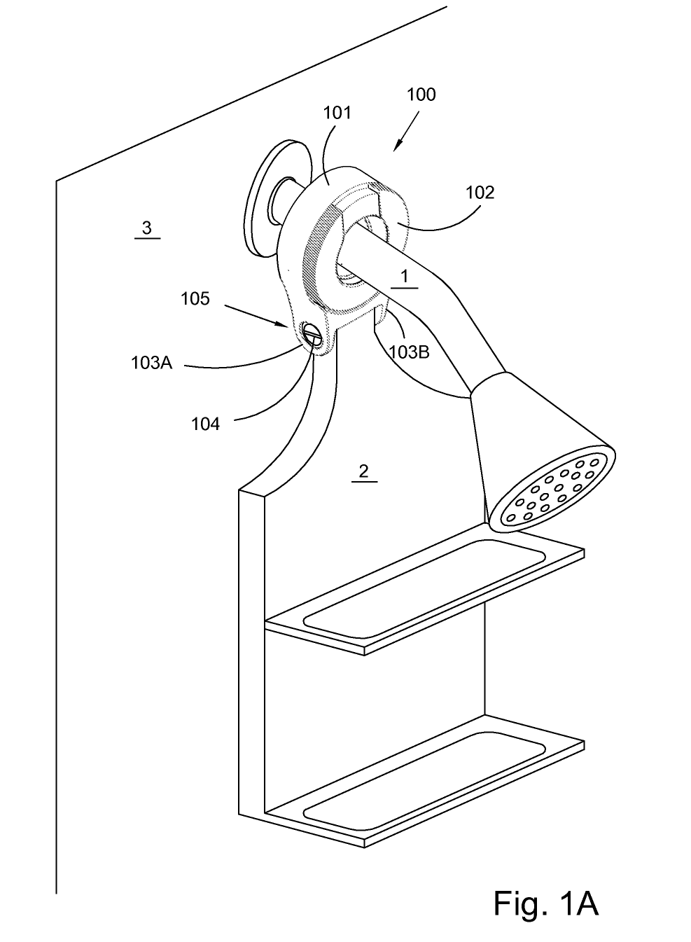

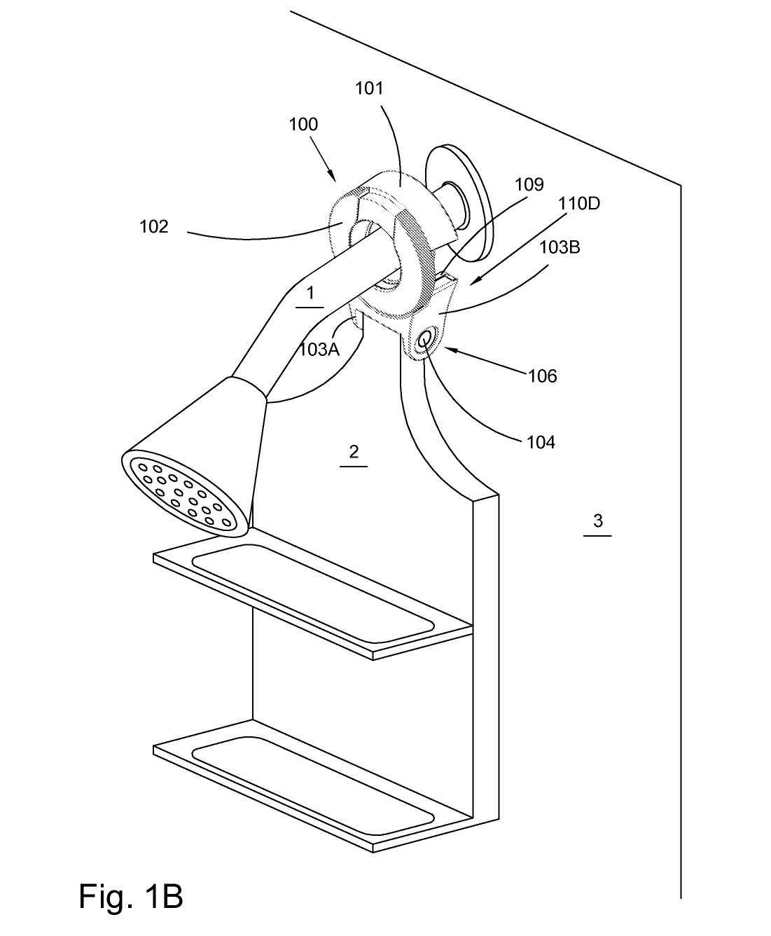

Adverting now to the figures, FIGS. 1A and 1B show perspective views of apparatus 100 secured to shower head pipe 1. Shower head pipe 1 is shown exiting wall 3 at a downward angle. It should be appreciated that shower head pipe 1 could be any type of pipe, for example, an s-shaped extension shower arm, a straight arm, or a bent arm. As discussed below, apparatus 100 is structured to be securable to any shower head pipe regardless of the angle at which the pipe exits a shower wall. Additionally, as discussed below, apparatus 100 is arranged to be securable around most pipes. Apparatus 100 is shown supporting typical shower caddy 2; apparatus 100 is in the locked position. Apparatus 100 broadly includes outer member 101, locking member 102, leg 103A, leg 103B, and pin 104.

Pin 104 connects legs 103A and 103B between aperture 105 and aperture 106. Aperture 105 is arranged within leg 103A and aperture 106 is arranged within leg 103B. In a preferred embodiment, apertures 105 and 106 are substantially similar and parallel to accommodate pin 104. In a preferred embodiment, apertures 105 and 106 are circular. Pin 104 is a typical slotted screw; however, it should be appreciated that any suitable screw is contemplated. Pin 104 is offset from shower head pipe 3 so that shower caddy 2 can hang vertically regardless of the bend in shower head pipe 3.

In a preferred embodiment, outer member 101, locking member 102, leg 103A and leg 103B are made of acrylonitrile butadiene styrene (ABS) plastic. Pin 104 is made of any suitable metal. As shown in FIG. 1B, when apparatus 100 is in the locked position, outer member 101 is still open proximate opening 110D. Apparatus 100 further includes inner member 109.

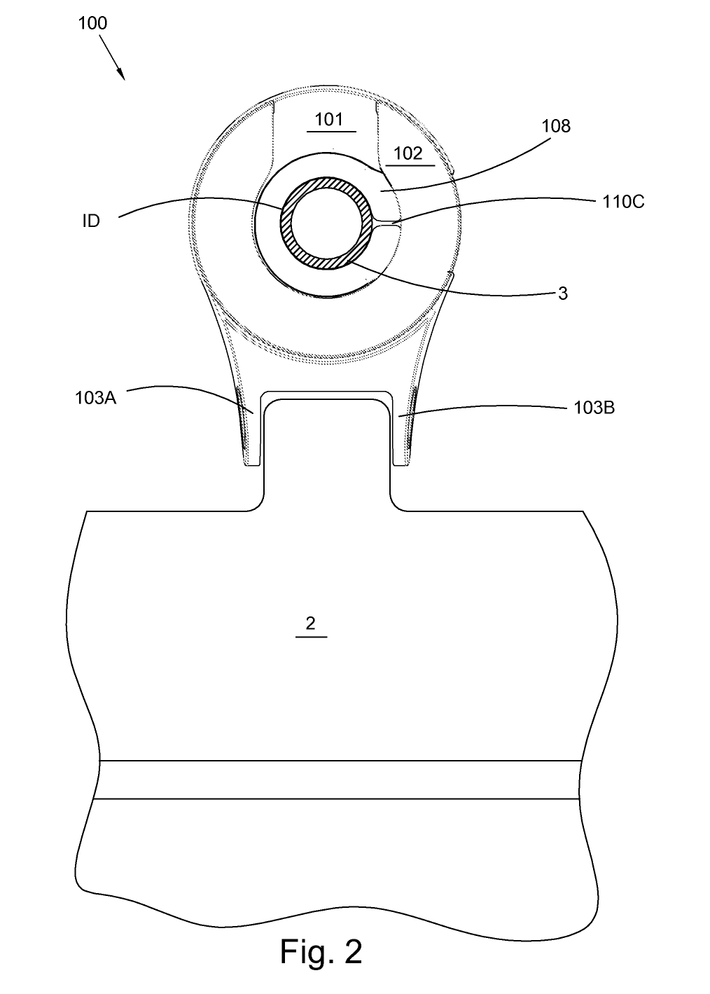

FIG. 2 shows a front view of apparatus 100 as it appears in FIGS. 1A and 1B. Resilient member 108 surrounds shower head pipe 3. Inner diameter ID of resilient member 108 is arranged to engage shower head pipe 3. Once apparatus 100 is secured around shower head pipe 3, the downward force applied by apparatus 100 prevents apparatus 100 from moving or slipping around or along shower head pipe 3. In the locked position, locking member 102 prevents apparatus 100 from disengaging with shower head pipe 3. Resilient member 108 is arranged between outer member 101 and inner member 109. Resilient member 108 is preferably made of rubber; however, any suitable alternative can be used.

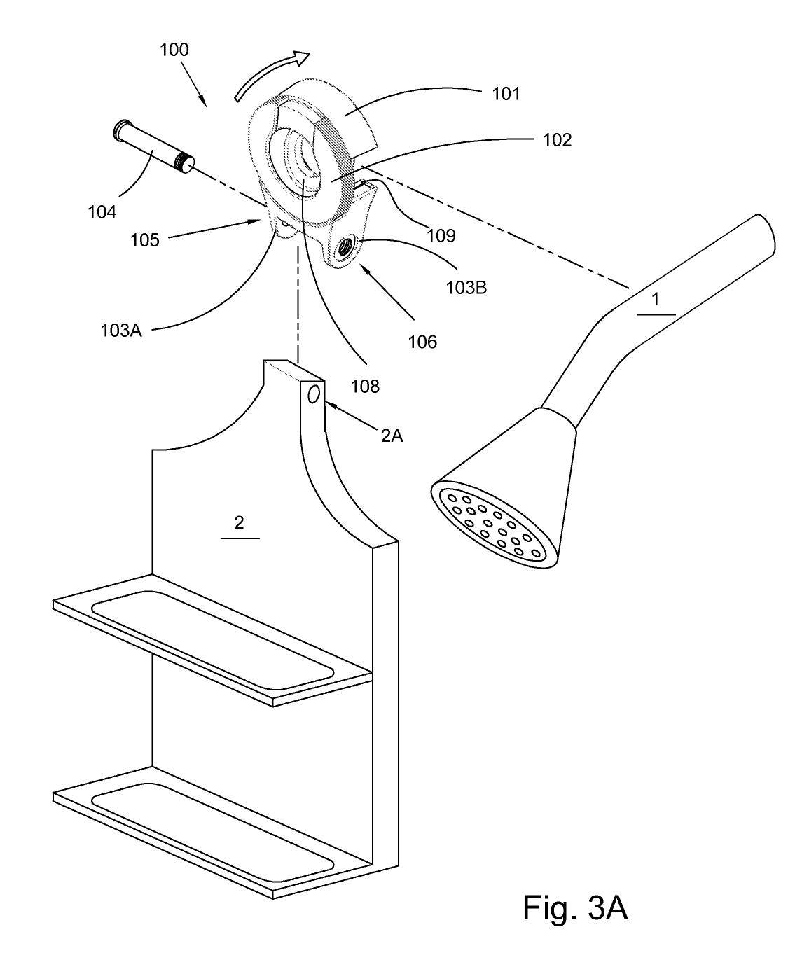

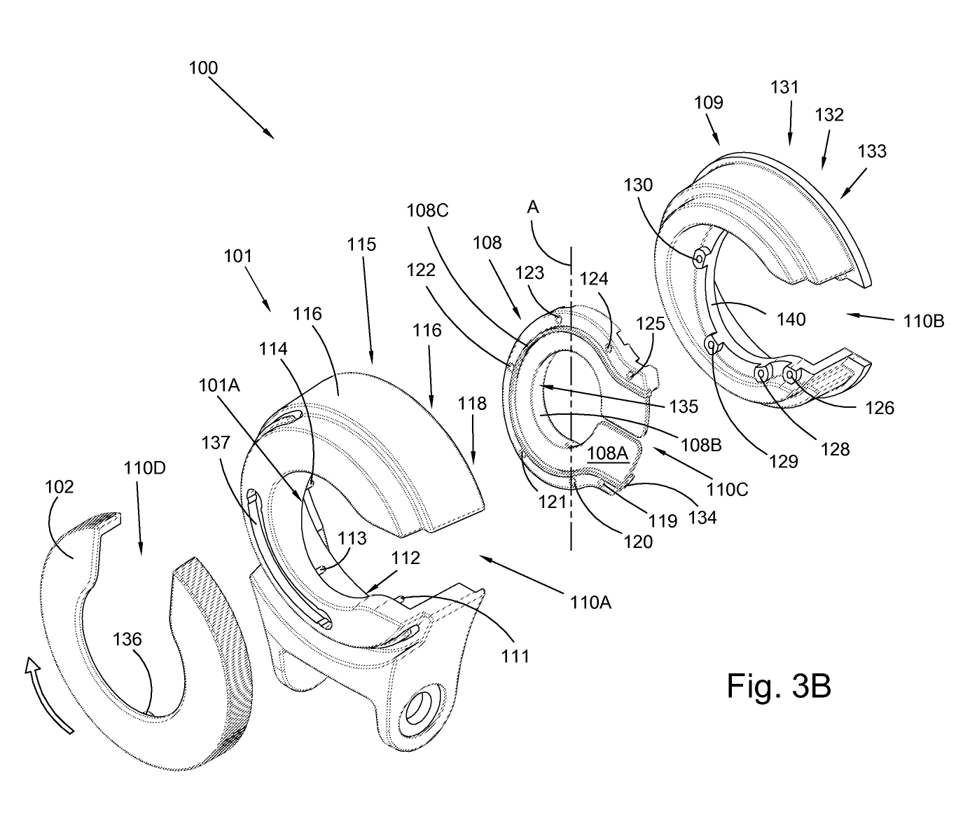

Apparatus 100 is shown in FIG. 3A with pin 104 removed from apertures 105 and 106. To secure apparatus 100 to shower caddy 2, shower caddy 2 includes through-bore 2A proximate the top of caddy 2 to receive pin 104. Once through-bore 2A of shower caddy 2 is aligned with apertures 105 and 106, pin 104 can be slid through through-bore 2A of shower caddy 2 and secured. In FIG. 3A, in order to arrange apparatus 100 around shower head pipe 3, locking member 102 is rotated clockwise approximately 90 degrees in the direction shown. The direction of rotation of locking member 102 is also shown in FIG. 3B.

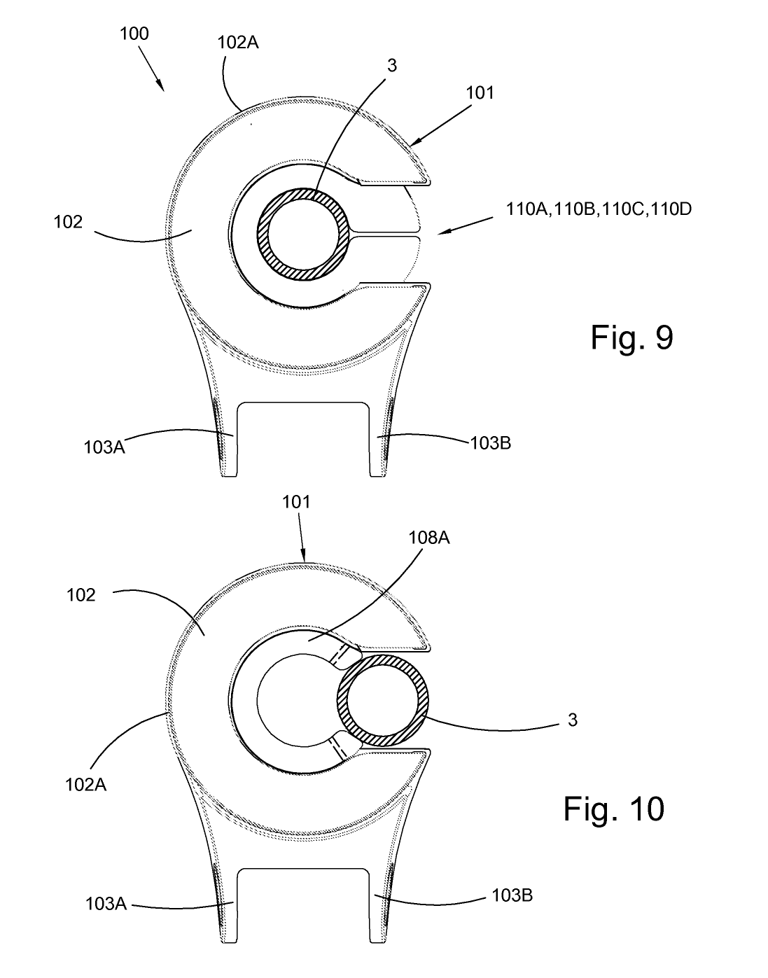

FIG. 3B shows an exploded view of apparatus 100 without pin 104. As described above, resilient member 108 is arranged between outer member 101 and inner member 109. Apparatus 100 includes openings 110A, 110B, 110C and 110D. Opening 110A is arranged within outer member 101. Opening 110B is arranged within inner member 109. Opening 110C is arranged within resilient member 108. Opening 110D is arranged within locking member 102. As shown, opening 110D is not aligned with openings 110A, 110B and 110C because locking member 102 is rotated in the locked position. When locking member 102 is rotated clockwise approximately 90 degrees (as shown in FIGS. 9 and 10), opening 110D is aligned with openings 110A, 110B and 110C. When openings 110A, 110B, 110C and 110D are aligned, apparatus 100 can be positioned around shower head pipe 3.

Plurality of protrusions 111, 112, 113, 114, 115, 116, and 118, preferably seven protrusions, are arranged within outer member 101 to penetrate plurality of holes 119, 120, 121, 122, 123, 124 and 125 in resilient member 108; there are preferably seven holes within resilient member 108. Plurality of protrusions 111, 112, 113, 114, 115, 116, and 118 are arranged to engage plurality of hollow members 126, 128, 129, 130, 131, 132 and 133 within inner member 109. Plurality of hollow members 126, 128, 129, 130, 131, 132 and 133 are correspondingly shaped to receive plurality of protrusions 111, 112, 113, 114, 115, 116, and 118. Preferably, plurality of protrusions 111, 112, 113, 114, 115, 116, and 118 are cylindrical and plurality of hollow members 126, 128, 129, 130, 131, 132 and 133 each include a cylindrical recess to accommodate plurality of protrusions 111, 112, 113, 114, 115, 116, and 118 which are cylindrical. Both outer member 101 and inner member 109 are preferably made of ABS plastic. Outer member 101 is securable to inner member 109 with resilient member 108 there between by ultrasonic welding, preferably. It should be appreciated that outer member 101 and inner member 109 could be secured by any other suitable means.

Preferably, locking member 102 is rotatably secured to outer member 101 via a tongue and groove mechanism. Locking member 102 includes extension 136 which is slidable along arcuate channel 137 within outer member 101. Extension 136 and arcuate channel 137 limit the rotation of locking member 102 with respect to outer member 101. As locking member 102 is rotated clockwise 90 degrees, extension 136 slides upward along arcuate channel 137.

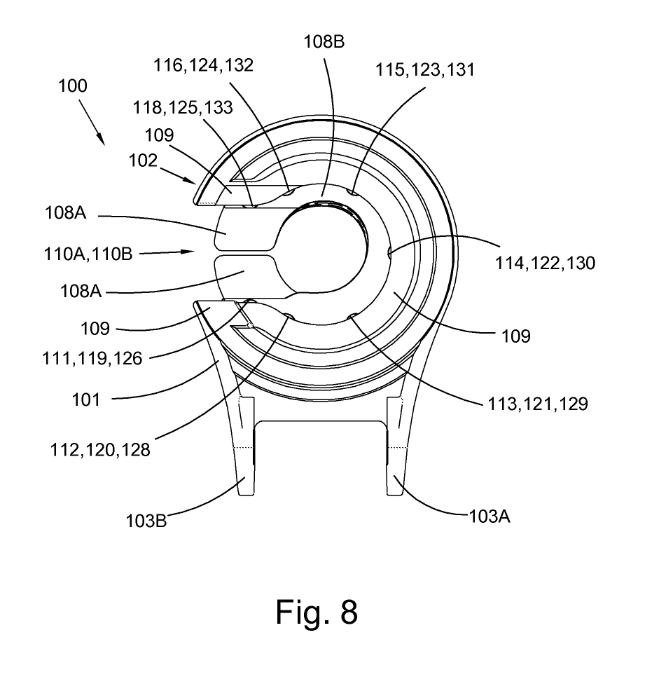

As shown in FIG. 3B, resilient member 108 is angled with respect to longitudinal axis A. Inner contour 101A of outer member 101 and inner contour 140 of inner member 109 are also angled with respect to longitudinal axis A. Resilient member 108 has outer contour 134 which is substantially planar in the plane which is perpendicular with respect to longitudinal axis A. Resilient member 108 also has inner contour 135. Preferably, inner contour 135 of resilient member 108 has offset contact surfaces. In other words, preferably, inner contour 135 is not substantially planar in the plane which is perpendicular with respect to longitudinal axis A. The offset contact surfaces of resilient member 108 are formed by angled planar surface 108A and substantially U-shaped lip 108B (see FIG. 8). U-shaped lip 108B is oriented in substantially the same way as outer member 101 and inner member 109. In other words, the “open” portion of U-shaped lip 108B is aligned with openings 110A and 110B. Angled planar surface 108A forms opening 110C whereas U-shaped lip 108B is nonexistent proximate opening 110C. Adverting back to FIG. 3B, the bottom half of angled planar surface 108A of resilient member 108 is angled towards locking member 102; whereas the top half of angled planar surface 108A is angled away from locking member 102. The bottom of inner contour 101A of outer member 102 is also angled towards locking member 102; whereas the top of inner contour 101A of outer member 102 is angled away from locking member 102. Similarly, the bottom of inner contour 140 of inner member 109 is angled toward locking member 102; whereas the top of inner contour 140 of inner member 109 is angled away from locking member 102. The top and bottom halves of angled planar surface 108A are preferably planar. U-shaped lip 108B protrudes rearwardly from angled planar surface 108A (see FIG. 5).

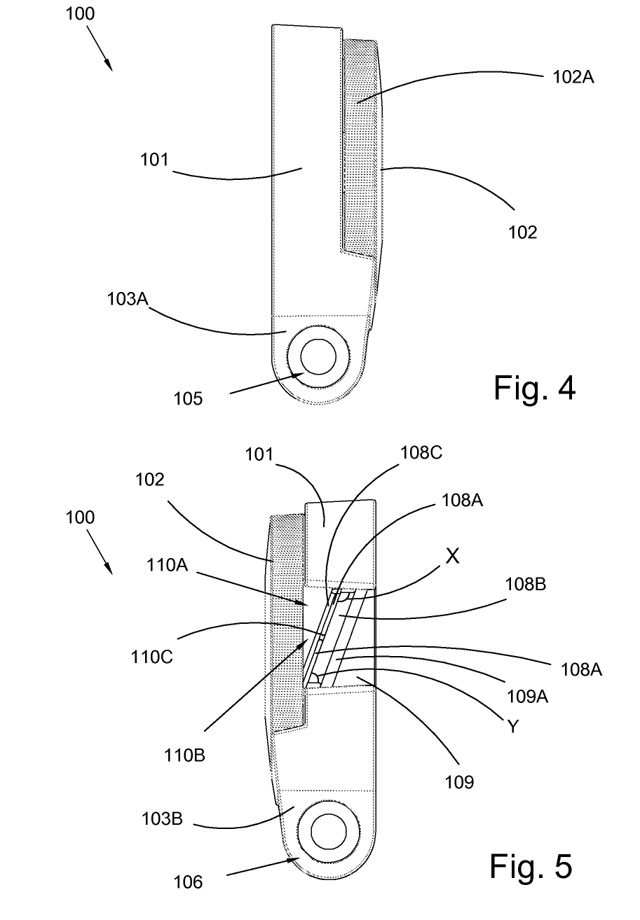

FIG. 4 shows a left side elevational view of apparatus 100 assembled. Locking member 102 includes gripping surface 102A arranged around the outer circumference. Gripping surface 102A facilitates the rotation of locking member 102 with respect to outer member 101.

FIG. 5 shows a right side elevational view of apparatus 100 assembled. Locking member 102 is in the locked position because opening 110D is not visible. Openings 110A, 110B and 110C are aligned. Angled planar surface 108A of resilient member 108 is shown forming opening 110C; angled planar surface 108A is arranged above and below opening 110C. Resilient member 108 further includes border 108C which is arranged along the contact surface between resilient member 108 and outer member 101 and the contact surface between resilient member 108 and inner member 109. Referring to FIG. 3B, border 108C engages contour 101A of outer member 101. Accordingly, border 108C and contour 101A are angled in substantially the same fashion. Referring back to FIG. 5, U-shaped lip 108B is shown protruding rearwardly or rightwardly from angled planar surface 108A Inner member 109 is shown to the right of resilient member 108. Inner member 109 includes angled portion 109A. Angled portion 109A and resilient member 108 are angled in substantially similar fashion. U-shaped lip 108B forms angles X and Y with respect to angled planar surface 108A. Angle X is preferably greater than 90 degrees and angle Y is preferably less than 90 degrees. Shower head pipe 3 rests along inner contour 135 of resilient member 108. Due to the angles created by U-shaped lip 108B and angled planar member 108A, shower head pipe 3, regardless of the angle of the pipe, can be secured within apparatus 100.

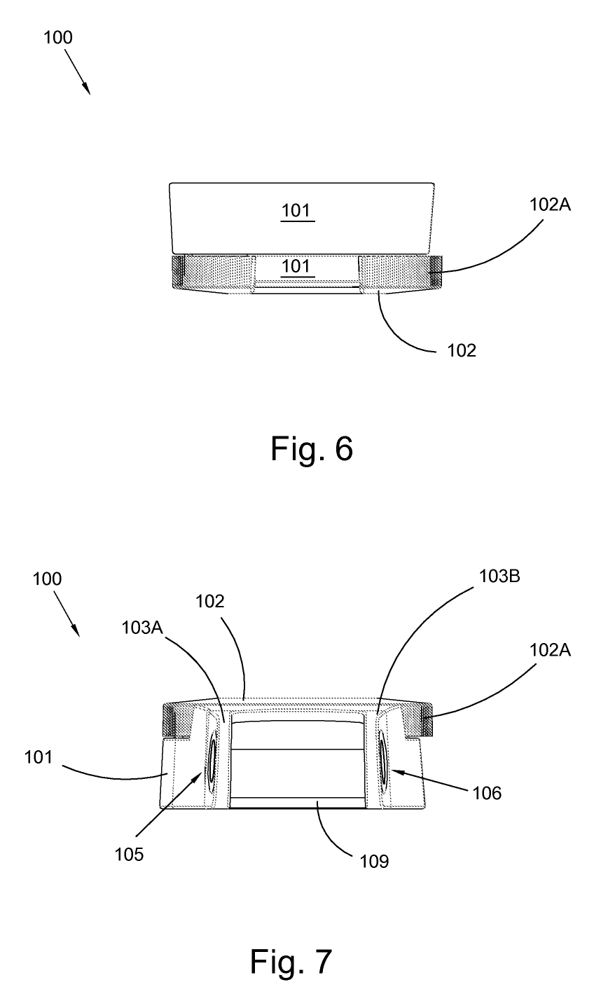

FIG. 6 is a top down view of apparatus 100. FIG. 7 is a bottom up view of apparatus 100.

FIG. 8 shows a rear elevational view of apparatus 100 without pin 104. The engagement of protrusion 111, hole 119, and hollow member 126 is shown. Similarly, the engagement of protrusion 112, hole 120, and hollow member 128 is shown. The engagement of protrusion 113, hole 121, and hollow member 129 is shown. The engagement of protrusion 114, hole 122, and hollow member 130 is shown. The engagement of protrusion 115, hole 123, and hollow member 131 is shown. The engagement of protrusion 116, hole 124, and hollow member 132 is shown. The engagement of protrusion 118, hole 125, and hollow member 133 is shown. The distinction between angled planar member 108A and U-shaped lip 108B is shown. The offset contact surfaces of U-shaped lip 108B are shown; the top curved section is angled upward and rearwardly from angled planar surface 108A whereas the bottom curved section is angled downward and inwardly toward angled planar surface 108A. Opening 110C is shown formed within angled planar member 108A.

FIG. 9 shows a front elevational view of apparatus 100 with locking member 102 in the unlocked position. When locking member 102 is unlocked, apparatus 100 can receive shower head pipe 3 via openings 110A, 110B, 110C and 110D.

As shown in FIG. 10, when locking member 102 is in the unlocked position, shower head pipe 3 is removable from apparatus 100 via openings 110A, 110B, 110C and 110D. Angled planar surface 108A of resilient member 108 are bendable to allow shower head pipe 3 to pass.

In a preferred embodiment, outer member 101, locking member 102, resilient member 108 and inner member 109 are substantially c-shaped. In other words they are substantially circular with an opening. Additionally, in a preferred embodiment, outer member 101, locking member 102, resilient member 108 and inner member 109 are concentric.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### REFERENCE NUMBERS

1 pipe
2 typical shower caddy
2A through-bore
3 wall
100 device
101 outer member
102 locking member
103A leg
103B leg
104 pin
105 aperture
106 aperture
108 resilient member
108A angled planar surface
108B U-shaped lip
108C border
109 inner member
110A opening
110B opening
110C opening
110D opening
111 protrusion
112 protrusion
113 protrusion
114 protrusion
115 protrusion
116 protrusion
118 protrusion
119 hole
120 hole
121 hole
122 hole
123 hole
124 hole
125 hole
126 hollow member
128 hollow member
129 hollow member
130 hollow member
131 hollow member
132 hollow member
133 hollow member
134 outer diameter
135 inner diameter
136 extension
137 arcuate channel
X angle
Y angle

What is claimed is:

1. An apparatus for securing bathroom accessories, comprising:
a housing operatively arranged to engage a shower head pipe, said housing comprising an opening; and,
a locking member rotatably secured to said housing; said locking member operatively arranged to close said opening of said housing.

2. The apparatus recited in claim 1, wherein said housing and said locking member are integral.

3. The apparatus recited in claim 1, wherein said housing further comprises an outer member, an inner member and a resilient member, and said inner member and said resilient member are arranged concentrically within said outer member.

4. The apparatus recited in claim 1, wherein said housing and said locking member are concentric.

5. The apparatus recited in claim 1, wherein said housing further comprises legs operatively arranged to receive a pin, where said legs and pin are operatively arranged to support at least one bathroom accessory.

6. The apparatus recited in claim 5, wherein said legs are substantially parallel.

7. An apparatus for securing bathroom accessories, comprising:
a first substantially c-shaped member;
a second substantially c-shaped member fixedly secured to said first substantially c-shaped member; and,
a resilient member arranged between said first substantially c-shaped member and said second substantially c-shaped member;
wherein said resilient member is operatively arranged to surround a shower head pipe and prevent said first substantially c-shaped member and said second substantially c-shaped member from slipping.

8. The apparatus recited in claim 7, further comprising a locking member operatively arranged to prevent said first substantially c-shaped member and said second substantially c-shaped member from disengaging from said shower head pipe.

9. The apparatus recited in claim 8, wherein said locking member is rotatably secured to said first substantially c-shaped member.

10. The apparatus recited in claim 7, wherein said resilient member comprises offset contact surfaces.

11. The apparatus recited in claim 7, wherein said second substantially c-shaped member and said resilient member are arranged concentrically within said first substantially c-shaped member.

12. The apparatus recited in claim 7, wherein said first substantially c-shaped member, second substantially c-shaped member and said resilient member are integral.

13. An apparatus for securing bathroom accessories, comprising:
a housing operatively arranged to engage a shower head pipe, said housing comprising:
an outer member;
an inner member; and,
a resilient member arranged between said outer member and said inner member; and,
a locking member rotatably secured to said housing;
wherein said locking member is concentric with said housing.

14. The apparatus recited in claim 13, wherein said resilient member is arranged at an angle with respect to said locking member.

15. The apparatus recited in claim 13, wherein said housing and said locking member are integral.

16. The apparatus recited in claim 13, wherein said housing further comprises legs operatively arranged to receive a pin, where said legs and pin are operatively arranged to support at least one bathroom accessory.

17. The apparatus recited in claim 16, wherein said legs are substantially parallel.

18. The apparatus recited in claim 16, wherein said inner member and said resilient member are arranged concentrically within said outer member.

19. The apparatus recited in claim 16, said resilient member is operatively arranged to surround a shower head pipe and prevent said housing from slipping.

20. The apparatus recited in claim 16, wherein said locking member is operatively arranged to prevent said housing from disengaging from said shower head pipe.
